(19) United States
(12) Patent Application Publication
(10) Pub. No.: US 2021/0338507 A1
(43) Pub. Date: Nov. 4, 2021

(54) Patient Lifting Harness

(71) Applicant: Kolby Kolek, San Antonio, TX (US)

(72) Inventor: Kolby Kolek, San Antonio, TX (US)

(21) Appl. No.: 17/245,110

(22) Filed: Apr. 30, 2021

Related U.S. Application Data
(60) Provisional application No. 63/018,594, filed on May 1, 2020.

(51) Int. Cl. A61G 7/10

(52) U.S. Cl. CPC A61G 7/1051

(57) ABSTRACT

A patient lifting harness is provided. The device includes a vest having a rear panel affixed to a front panel, wherein the front panel defines a first portion removably securable to a second portion via at least one fastener. The first portion and second portion are selectively movable between an open configuration and a closed configuration. The vest further includes an upper opening, a lower opening, and a pair of arm openings. A plurality of loop connectors is affixed to the rear panel, wherein the plurality of loop connectors includes an external loop having a plurality of cross members extending therebetween defining a plurality of loop openings. In some embodiments, a pair of thigh strap assemblies are affixed to the vest along the lower opening, wherein a loop connector of the plurality of loop connectors is affixed to each of the pair of thigh strap assemblies.

### CROSS REFERENCE TO RELATED APPLICATIONS

This application claims the benefit of U.S. Provisional Application No. 63/018,594 filed on May 1, 2020. The above identified patent application is herein incorporated by reference in its entirety to provide continuity of disclosure.

### BACKGROUND OF THE INVENTION

The present invention relates to patient lifting harnesses. More particularly, the present invention pertains to a patient lifting harness with a plurality of loop connectors defining multiple openings to allow precise distribution of force across a patient's body when positioning a patient for therapy.

Many patients have limited mobility that prevents proper rehabilitation after prolonged illnesses while bedridden. In order to retrain and rebuild the patient's muscles, therapists gradually increase the patient's strength through a series of exercises in various positions. Additionally, many medical treatments are more effective and beneficial when a patient is maintained in a particular position that may be difficult for the patient due to limited mobility or unconsciousness. However, due to the patient's limited mobility, maneuvering the patient into the required position can be particularly difficult and strenuous. Often, several additional medical professionals may be required to lift, maneuver, and hold the patient in a desired position while the exercise is performed. In particularly busy settings, patients may be unable to receive the desired therapy for a prolonged period due to a lack of available assistance. Alternatively, mechanical assistance is typically limited to merely lifting and moving a patient from one location to another via a sling device, such as from a bed to a wheelchair, and as such cannot aid in lifting a patient and maintaining the patient in a particular position. Therefore, a patient harness that can secure to a mechanical lifting apparatus to maintain a patient in a variety of positions is desired.

In light of the devices disclosed in the known art, it is submitted that the present invention substantially diverges in design elements from the known art and consequently it is clear that there is a need in the art for an improvement to existing patient lifting harnesses. In this regard, the instant invention substantially fulfills these needs.

### SUMMARY OF THE INVENTION

In view of the foregoing disadvantages inherent in the known types of patient lifting harnesses now present in the known art, the present invention provides a patient lifting harness wherein the same can be utilized for providing convenience for the user when positioning a patient for therapy.

The present system comprises a vest having a rear panel affixed to a front panel, wherein the front panel defines a first portion removably securable to a second portion via at least one fastener. As such, the first portion and second portion are selectively movable between an open configuration and a closed configuration. The vest further comprises an upper opening, a lower opening, and a pair of arm openings therethrough. A plurality of loop connectors affixed to the rear panel, wherein the plurality of loop connectors comprises an external loop having a plurality of cross members extending therebetween defining a plurality of loop openings. In some embodiments, a pair of thigh strap assemblies are affixed to the vest along the lower opening, wherein a loop connector of the plurality of loop connectors is affixed to each of the pair of thigh strap assemblies. In some such embodiments, each of the pair of thigh strap assemblies comprise a lateral panel and a pair of securement straps extending from a distal end of the lateral panel, wherein the securement straps include complementary fasteners thereon. In another embodiment, the securement straps comprise an elastic material. In other embodiments, the lateral panel includes opposing arcuate edges defining a front opening and a rear opening through the pair of thigh strap assemblies.

In some embodiments, the arm openings terminate at a shoulder region of the vest. In another embodiment the fasteners are secured to adjustable straps extending from the front portion. In other embodiments, an interior layer of the vest includes a padded material therein. In yet another embodiment, the plurality of loop connectors is disposed on opposing lateral sides of the rear panel adjacent to each of the arm openings and the lower opening. In some embodiments, a reinforcement layer is disposed about a proximal end of each of the plurality of loop connectors along the vest. In another embodiment, each of the external loop and the plurality of cross members comprise an inelastic material. In other embodiments, each of the plurality of cross members are color coded to identify a distance of each of the plurality of loop openings from the vest. In yet another embodiment, the plurality of cross members is disposed at regular intervals along a length of the external loop.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a front view of an embodiment of the patient lifting harness.

FIG. 1B shows a rear view of an embodiment of the patient lifting harness.

FIG. 2 shows a close-up view of the loop connector of an embodiment of the patient lifting harness.

FIG. 3 shows a front view of the thigh strap assemblies of an embodiment of the patient lifting harness.

FIG. 4 shows a perspective view of an embodiment of the patient lifting harness in use.

### DETAILED DESCRIPTION OF THE INVENTION

Reference is made herein to the attached drawings. Like reference numerals are used throughout the drawings to depict like or similar elements of the patient lifting harness. The figures are intended for representative purposes only and should not be considered to be limiting in any respect.

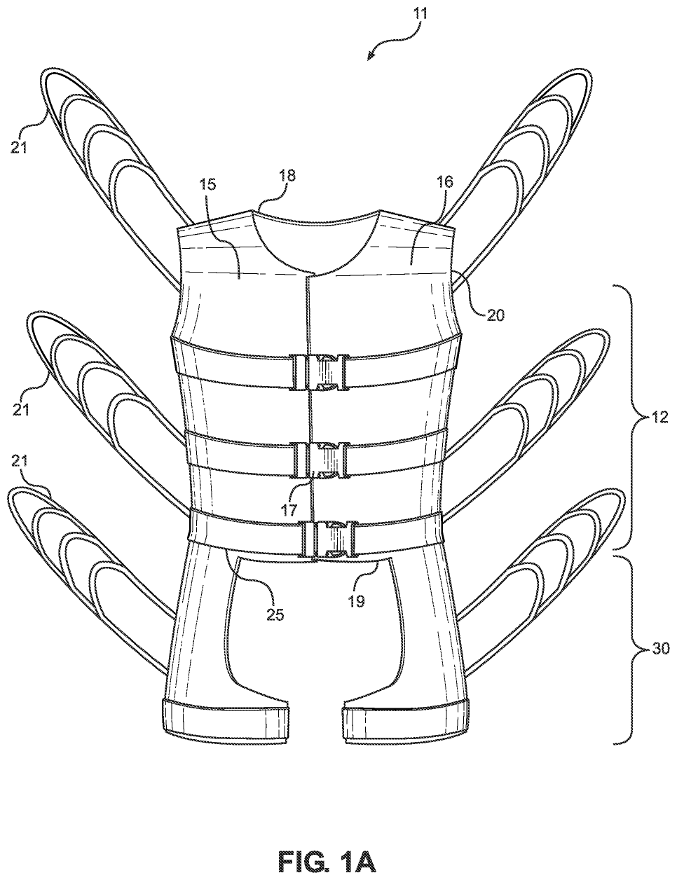

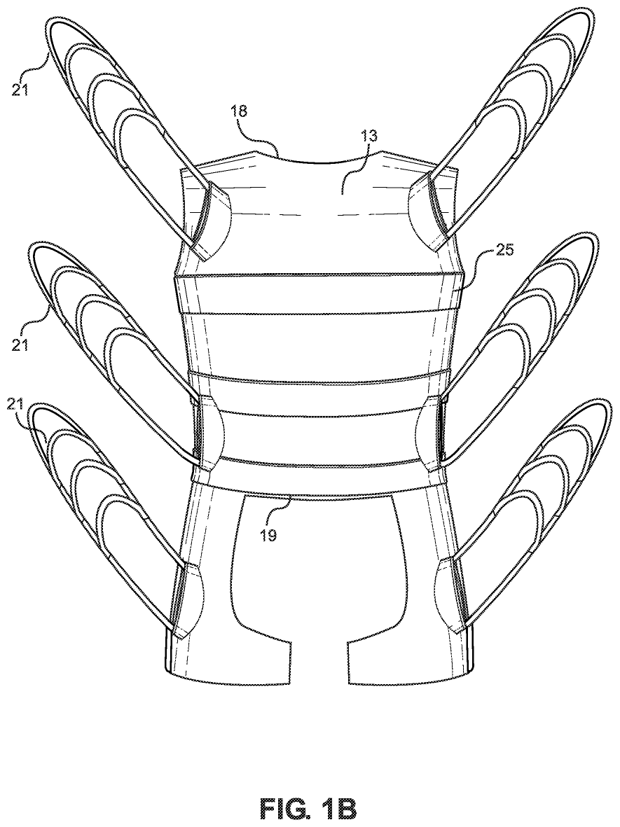

Referring now to FIGS. 1A and 1B, there is shown a front view of an embodiment of the patient lifting harness and a rear view of an embodiment of the patient lifting harness, respectively. The patient lifting harness 11 comprises a vest 12 having a front panel affixed to a rear panel 13 defining an upper opening 18, a lower opening 19, and a pair of arm openings 20, such that the vest 12 is securable over a torso of a patient. In the illustrated embodiment, the vest 12 comprises a sleeveless configuration, such that that pair of arm openings 20 terminate at a shoulder region of the vest 12. In this manner, the freedom of movement of the patient wearing the vest 12 is maximized. In some embodiments, the vest 12 comprises an interior padded layer to increase the comfort of the user during use. In some such embodiments, the padded layer comprises a memory foam material configured to compress to redistribute applied forces across the padding and return to an initial position upon the dissipation of the applied force. In some embodiments, the interior padded layer is disposed across an entirety of the vest 12. In other embodiments, the interior padded layer is isolated to the front panel as the applied forces are likely to be isolated to the front panel. As such, complexity and cost of manufacture may be reduced. In another embodiment, the interior padded layer may comprise a greater thickness adjacent to the pair of arm openings 20, the upper opening 18, and the lower opening 19, to minimize discomfort caused by the various openings 18, 19, 20 compressing into the patient's torso as the patient is supported by the patient lifting harness 11.

The front panel further comprises a first portion 15 removably securable to a second portion 16, such that the front panel is selectively movable between an open configuration and a closed configuration. At least one fastener 17 is disposed on each of the first portion 15 and the second portion 16, wherein the fastener 17 retains the front panel in the closed configuration. In the shown embodiment, the fasteners 17 comprise complementary buckle fasteners disposed on a distal end of adjustable straps 25 disposed about the vest 12. In some embodiments, the adjustable straps 25 comprise an elastic material configured to selectively adjust a length of each strap 25. In alternate embodiments, the adjustable straps 25 include an adjustment mechanism, such as a buckle, allowing the user to adjust the length of each strap 25. In this manner, the vest 12 can be utilized with patients of various sizes. In some embodiments, each adjustable strap 25 extends about an entirety of the vest 12 across the first portion 15, the rear panel 13, and the second portion 16 to further secure the vest 12 to a patient.

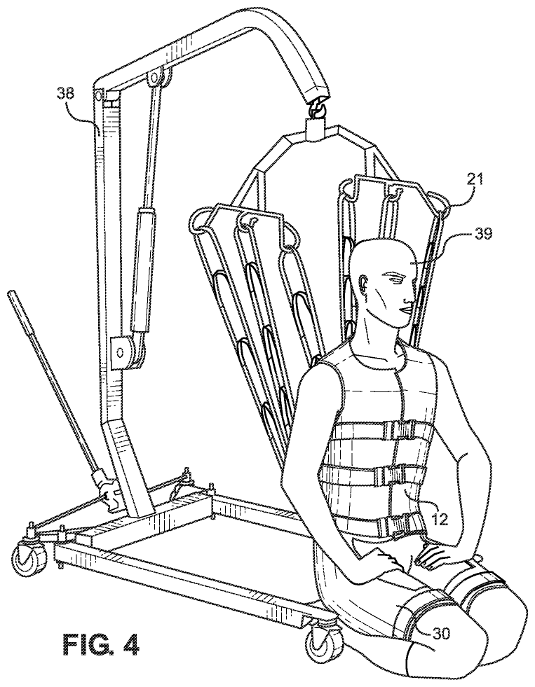

A plurality of loop connectors 21 are disposed across the rear panel 13 of the vest 12, wherein the plurality of loop connectors 21 are dimensioned to removably secure to an attachment mechanism of a patient lifting apparatus (as shown in FIG. 4, 38), such as a Hoyer lift. In this manner, the weight of the patient can be at least partially supported by the patient lifting apparatus to allow medical professionals to position and maneuver the patient more easily. In the shown embodiment, the plurality of loop connectors 21 are disposed on opposing lateral sides of the vest 12 adjacent to the pair of arm openings 20 and the lower opening 19, such that the weight of the patient is distributed across the entirety of the vest 12. In the illustrated embodiment, the patient lifting harness 11 further comprises a pair of thigh strap assemblies 30 affixed to the vest 12 along the lower opening 19. The pair of thigh strap assemblies 30 secure about each thigh of the patient and each comprise a loop connector 21 thereon. In this manner, the patient's weight is further distributed across the patient's body.

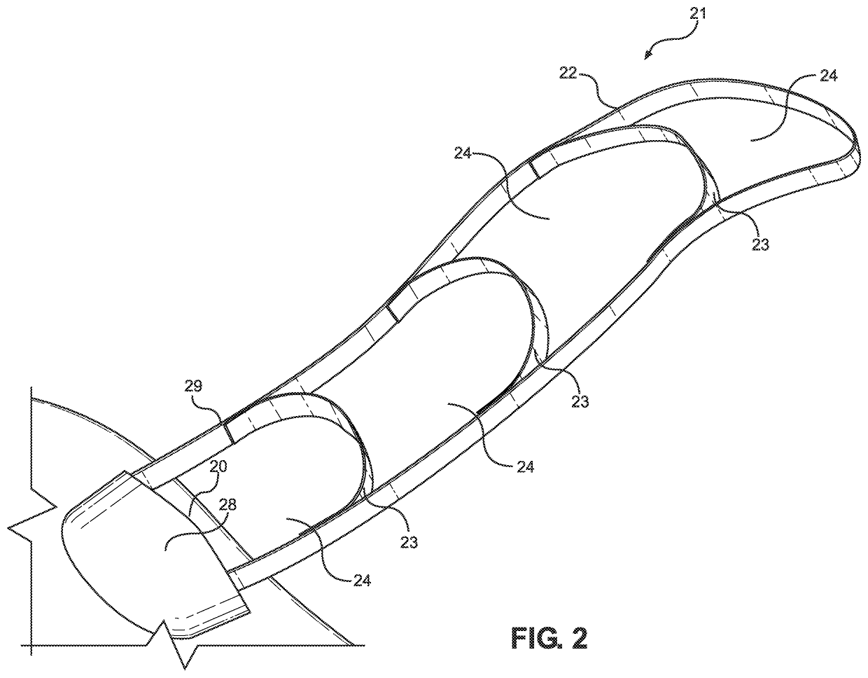

Referring now to FIG. 2, there is shown a close-up view of the loop connector of an embodiment of the patient lifting harness. In the illustrated embodiment, each loop connector 21 comprises an external loop 22 having a plurality of cross members 23 extending between opposing sides of the external loop 22, thereby defining a plurality of loop openings 24 therebetween. The plurality of loop openings 24 are dimensioned to receive a connector of the patient lifting apparatus therethrough, such that the user can adjust the connector's distance from the vest to alter the lifting angle of the patient. In the shown embodiment, a proximal end 29 of each loop connector 21 is permanently affixed to the vest along a reinforcement layer 28. The reinforcement layer 28 comprises an additional tear resistant material about the proximal end 29 of the loop connector 21 to increase the structural securement of the loop connector 21 to the vest. In the shown embodiment, the proximal end 29 of the loop connector 21 is secured adjacent to the arm opening 20. In some such embodiments, the proximal end 29 of the loop connector 21 is disposed within a pocket defined by the reinforcement layer 28, such that the loop connector 21 is affixed on an interior of the vest, further increasing the structural integrity of the loop connector 21. In some embodiments, each loop connector 21 comprises an inelastic material to reduce variation in forces applied to the patient as the patient is lifted. In the shown embodiment, the plurality of cross members 23 are disposed at regular intervals along the external loop 22, such that each of the plurality of loop openings 24 comprise an identical size. In some such embodiments, the external loop 22 is approximately one foot in length, and the plurality of cross members 23 are disposed at three-inch intervals along the external loop 22. In some embodiments, each of the plurality of cross members 23 comprises a distinct color to allow a user to readily identify a relative distance of each of the loop openings 24 from the vest.

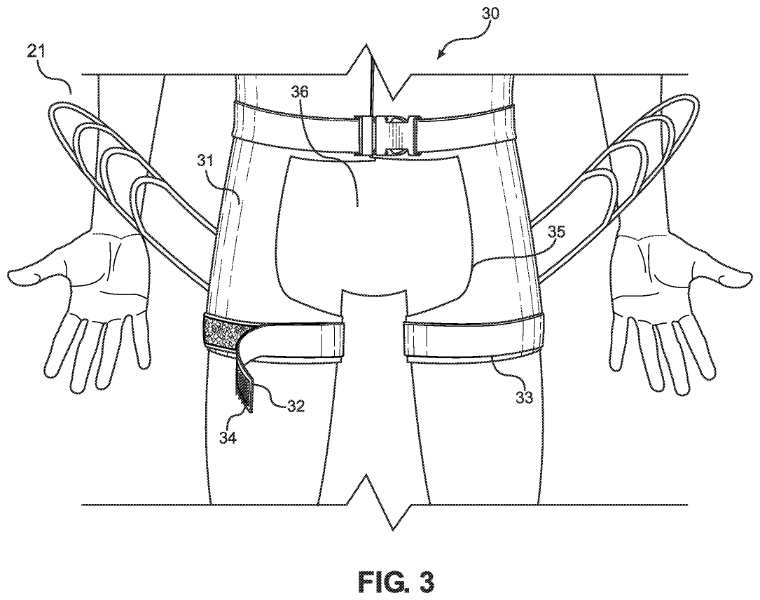

Referring now to FIG. 3, there is shown a front view of the thigh strap assemblies of an embodiment of the patient lifting harness. In the illustrated embodiment, the pair of thigh strap assemblies 30 comprise a lateral panel 31 affixed to the vest along the lower opening. In the shown embodiment, a pair of securement straps 32 extend from a distal end 33 of the lateral panel 31, wherein the pair of securement straps 32 include complementary fasteners 34. In the shown embodiment, the complementary fasteners 34 comprise hook and loop fasteners. In this manner, the pair of securement straps 32 are removably securable via the complementary fasteners 34. In some embodiments, the pair of securement straps 32 comprise an elastic material such that the securement straps 32 are selectively adjustable in length, thereby allowing the pair of securement straps 32 to secure around patients of various sizes. In such embodiments, the complementary fasteners 34 extend along a majority of the securement straps 32 to allow the securement straps 32 to secure to each other at various desired diameters. In the shown embodiment, each edge of the lateral panel 31 comprises an arcuate edge 35, such that the pair of thigh strap assemblies 30 define a front opening 36 and a rear opening (as shown in FIG. 1B) therethrough. The front opening 36 and the rear opening provide patient access for catheters, bedpans, and other medical needs. In the illustrated embodiment, the loop connectors 21 are disposed on each lateral panel 31 of the pair of thigh strap assemblies 30.

Referring now to FIG. 4, there is shown a perspective view of an embodiment of the patient lifting harness in use. In one use, the vest 12 is secured over the torso of the patient 39 via the adjustable straps and fasteners. In the shown embodiment, the pair of thigh strap assemblies 30 are further secured about the thighs of the patient 39. The plurality of loop connectors 21 are then affixed to a patient lifting apparatus 38, such as a Hoyer lift, at a desired distance from the vest 12. In this manner, the user can adjust the angle at which forces are distributed across the patient 39 to aid in maneuvering the patient 39 to a desired position for therapy. As the patient lifting apparatus 38 raises the patient 39, the medical professional can efficiently position the patient 39 with a minimal amount of effort, as well as minimal discomfort to the patient 39.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly, and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A patient lifting harness, comprising:
a vest having a rear panel affixed to a front panel;
wherein the front panel defines a first portion removably securable to a second portion via at least one fastener, such that the first portion and second portion are selectively movable between an open configuration and a closed configuration;
wherein the vest further comprises an upper opening, a lower opening, and a pair of arm openings therethrough;
a plurality of loop connectors affixed to the rear panel;
wherein the plurality of loop connectors comprises an external loop having a plurality of cross members extending therebetween defining a plurality of loop openings.

2. The patient lifting harness of claim 1, wherein the arm openings terminate at a shoulder region of the vest.

3. The patient lifting harness of claim 1, wherein the fasteners are secured to adjustable straps extending from the front portion.

4. The patient lifting harness of claim 1, wherein an interior layer of the vest includes a padded material therein.

5. The patient lifting harness of claim 1, wherein the plurality of loop connectors is disposed on opposing lateral sides of the rear panel adjacent to each of the arm openings and the lower opening.

6. The patient lifting harness of claim 1, further comprising a reinforcement layer about a proximal end of each of the plurality of loop connectors along the vest.

7. The patient lifting harness of claim 1, wherein each of the external loop and the plurality of cross members comprise an inelastic material.

8. The patient lifting harness of claim 1, wherein each of the plurality of cross members are color coded to identify a distance of each of the plurality of loop openings from the vest.

9. The patient lifting harness of claim 1, wherein the plurality of cross members is disposed at regular intervals along a length of the external loop.

10. A patient lifting harness, comprising:
a vest having a rear panel affixed to a front panel;
wherein the front panel defines a first portion removably securable to a second portion via at least one fastener, such that the first portion and second portion are selectively movable between an open configuration and a closed configuration;
wherein the vest further comprises an upper opening, a lower opening, and a pair of arm openings therethrough;
a plurality of loop connectors affixed to the rear panel;
wherein the plurality of loop connectors comprises an external loop having a plurality of cross members extending therebetween defining a plurality of loop openings;
a pair of thigh strap assemblies affixed to the vest along the lower opening;
wherein a loop connector of the plurality of loop connectors is affixed to each of the pair of thigh strap assemblies.

11. The patient lifting harness of claim 10, wherein the arm openings terminate at a shoulder region of the vest.

12. The patient lifting harness of claim 10, wherein the fasteners are secured to adjustable straps extending from the front portion.

13. The patient lifting harness of claim 10, wherein an interior layer of the vest includes a padded material therein.

14. The patient lifting harness of claim 10, wherein the plurality of loop connectors is disposed on opposing lateral sides of the rear panel adjacent to each of the arm openings and the lower opening.

15. The patient lifting harness of claim 10, further comprising a reinforcement layer about a proximal end of each of the plurality of loop connectors along the vest.

16. The patient lifting harness of claim 10, wherein each of the external loop and the plurality of cross members comprise an inelastic material.

17. The patient lifting harness of claim 10, wherein the plurality of cross members is disposed at regular intervals along a length of the external loop.

18. The patient lifting harness of claim 10, wherein each of the pair of thigh strap assemblies comprise a lateral panel and a pair of securement straps extending from a distal end of the lateral panel, wherein the securement straps include complementary fasteners thereon.

19. The patient lifting harness of claim 18, wherein the securement straps comprise an elastic material.

20. The patient lifting harness of claim 18, wherein the lateral panel includes opposing arcuate edges defining a front opening and a rear opening through the pair of thigh strap assemblies.
